(19) United States
(12) Patent Application Publication
(10) Pub. No.: US 2012/0155695 A1
(43) Pub. Date: Jun. 21, 2012

(54) SPEAKER DEVICE FOR A PORTABLE TERMINAL

(75) Inventor: Jee-Tae PARK, Gyeongsangbuk-do (KR)

(73) Assignee: SAMSUNG ELECTRONICS CO., LTD., Gyeonggi-Do (KR)

(21) Appl. No.: 13/329,541

(22) Filed: Dec. 19, 2011

(30) Foreign Application Priority Data
Dec. 20, 2010 (KR) 10-2010-0130733

(51) Int. Cl. H04R 9/06

(52) U.S. Cl. 381/396

(57) ABSTRACT

A speaker device for a portable terminal includes: an electromagnetic wave noise shield member mounted on a circuit board; a speaker unit mounted on the electromagnetic wave noise shield member, the speaker unit producing sound; and a resonance space formed by the electromagnetic wave noise shield member and the circuit board, the sound produced from the speaker unit being partially provided to the resonance space. Since the speaker device configured as described above secures a resonance space using an electromagnetic wave noise shield member mounted on a circuit board in a portable terminal, it is possible to improve sound quality while maintaining the size of the portable terminal to be the same as a separate resonance space is not required.

### CLAIM OF PRIORITY

This application claims the priority under 35 U.S.C. §119 of an application entitled “Speaker Device For Portable Terminal” filed in the Korean Intellectual Property Office on Dec. 20, 2010 and assigned Serial No. 10-2010-0130733, the contents of which are hereby incorporated by reference.

### BACKGROUND OF THE INVENTION

1. Field of the Invention

The present invention relates to a portable terminal, and more particularly to a speaker device for a portable terminal.

2. Description of the Related Art

In general, a portable terminal provides various functions, such as voice and text messaging, and multimedia services including games and motion pictures. Such portable terminals are fabricated in various types, such as a digital diary, a palm PC (personal computer), a portable game machine, a moving picture/music reproducer, a cellular phone, and a notebook PC.

Recently, as a digital diary function and a multimedia function have been available in a mobile communication terminal, a user can enjoy banking business, such as micro payment, and various other contents, such as game/multimedia services, as well as the traditional voice function via a single mobile communication terminal. That is, mobile communication terminals have been evolved to enable banking transactions, a multimedia function, and a simple business function including transmission/reception of Internet or mail.

As the multimedia and communication settings are readily available, the need for a larger display in a portable terminal is growing. However, with the enlargement of a display device in a portable terminal, a problem of miniaturization and weight-lightening of such a portable terminal is not being addressed. As a result, spaces for other devices, for example, an input device, such as a keypad, and an output device, such as a speaker device, are gradually being limited. In the case of the input device, a keypad can be substituted by a touch screen. However, there is difficulty in securing a space for mounting a speaker device.

Moreover, with the popularity of a multimedia function, it is also required to improve sound quality in a portable terminal. However, in order to improve the sound quality, the volume of the speaker of the portable terminal must be increased. In other words, with a speaker device miniaturized without securing a separate resonance space, it may be sufficient to conduct voice communication or the like, however the sound quality is deteriorated at a frequency above the human voice band. Accordingly, in order to strengthen middle and bass sound, it is necessary to secure a resonance space in a speaker device. However, it will become more difficult to secure a resonance space of a speaker device in a portable terminal which is continuously being miniaturized.

### SUMMARY OF THE INVENTION

Accordingly, the present invention has been made to solve the above-mentioned problems occurring in the prior art and provides additional advantages, by providing a speaker device which can contribute to the improvement of sound quality of a portable terminal in conjunction with a multimedia function.

Another aspect of the present invention is to provide a speaker device which is easy to secure a resonance in a miniaturized portable terminal.

In accordance with an aspect of the present invention, a speaker device for a portable terminal includes: an electromagnetic wave noise shield member mounted on a circuit board; a speaker unit mounted on the electromagnetic wave noise shield member, the speaker unit producing sound; and a resonance space formed by the electromagnetic wave noise shield member and the circuit board, the sound produced from the speaker unit being partially provided to the resonance space.

The electromagnetic wave noise shield member is preferably formed from a metallic material.

The speaker device may further include a reception space formed on the outer face of the electromagnetic wave noise shield member by depressing a part of the outer face in the direction toward the circuit board, wherein the speaker unit is arranged in the reception space.

The speaker device may further include rear openings formed to extend the reception space to the inner face of the electromagnetic wave noise shield member, wherein the sound produced from the speaker unit is partially provided to the resonance space through the rear openings.

In addition, the terminal includes a housing to receive the circuit board, wherein the electromagnetic wave noise shield member is preferably interposed between the housing and the circuit board.

The speaker device may further include a reception space formed on the outer face of the electromagnetic wave noise shield member by depressing the outer face in the direction toward the circuit board, wherein the speaker unit is preferably arranged in the reception space.

In addition, the speaker device may further include a sealing member, one side of which is attached to the electromagnetic wave noise shield member, and the other side of which is attached to the inner face of the housing, wherein the sealing member is preferably arranged on the outer face of the electromagnetic wave noise shield member to surround the reception space.

Moreover, the speaker device may further include front openings formed to extend from the inner face of the housing facing to the speaker unit to the outer face of the housing.

The speaker device configured as described above secures a resonance space using an electromagnetic wave noise shield member mounted on a circuit board in a portable terminal, thus it is not necessary to secure a separate resonance space for improving sound quality. In other words, since the space, which is formed by the electromagnetic wave noise shield member for shielding the electromagnetic wave interference between circuit devices or the electromagnetic waves of the circuit devices from affecting the outside, is used as a resonance space, it is possible to prevent the size of a portable terminal from being increased so as to secure a separate resonance space. Therefore, in accordance with the present invention, there is an advantage in that the sound quality of a portable terminal can be improved without increasing the size of the portable terminal.

In accordance with another aspect of the present invention, a mobile terminal includes: a housing having a front cover and a rear cover having openings; a circuit board disposed within the housing; an electromagnetic wave noise shield member mounted on the circuit board, thus defining a resonance space therebetween; and a speaker unit mounted on the electromagnetic wave noise shield member so that an audio output the speaker unit is partially provided to the resonance space. The electromagnetic wave noise shield member includes a reception space having openings so that the sound produced from the speaker unit is partially provided to the resonance space. Similarly, the rear cover of the housing includes openings over the speaker unit to output audio therefrom to the exterior.

### BRIEF DESCRIPTION OF THE DRAWINGS

The above and other aspects, features and advantages of the present invention will be more apparent from the following detailed description taken in conjunction with the accompanying drawings, in which:

FIG. 1 is an exploded perspective view of a portable terminal having a speaker device in accordance with an embodiment of the present invention; and

FIG. 2 is a cross-sectional view of the portable terminal shown in FIG. 1.

### DETAILED DESCRIPTION OF THE INVENTION

Hereinafter, embodiments of the present invention will be described with reference to the accompanying drawings. For the purposes of clarity and simplicity, a detailed description of known functions and configurations incorporated herein will be omitted as it may make the subject matter of the present invention rather unclear.

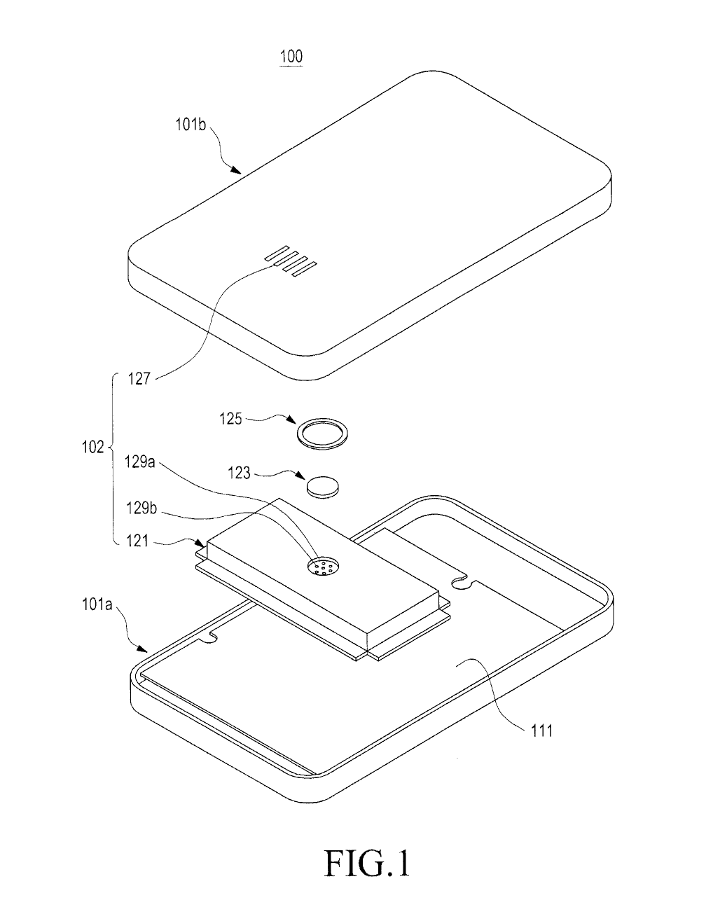

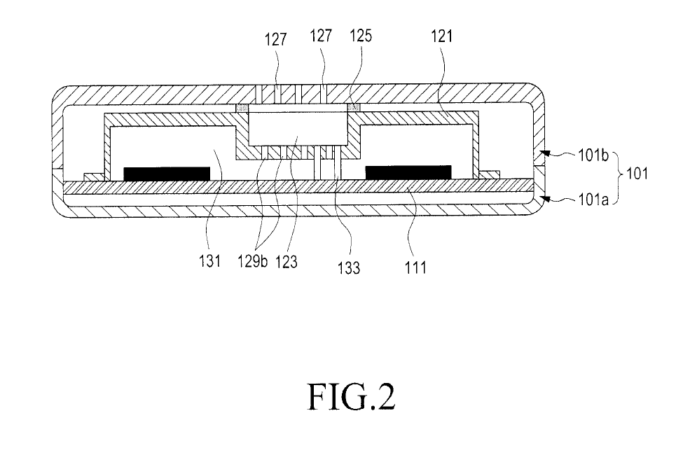

FIG. 1 is an exploded perspective view of a portable terminal having a speaker device 102 in accordance with an embodiment of the present invention, and FIG. 2 is a cross-sectional view of the portable terminal shown in FIG. 1.

As shown in FIGS. 1 and 2, the speaker device 102 includes an electromagnetic wave noise shield member 121 mounted on a circuit board 111, a speaker unit 123 for producing sound, and a resonance space 131 formed by mounting the electromagnetic wave noise shield member 121 on the circuit board 111.

The terminal 100 is a portable terminal having a bar-type housing, in which the housing 101 consists of a front case 101a and a rear case 101b coupled to each other. Although not shown, a display device, a home key or the like may be arranged on the front side of the housing 101. The circuit board 111 is mounted in the front case 101a, and the display device is disposed on one side of the circuit board 111 to be oriented to the front side of the housing 101. The rear case 101b is coupled to the rear side of the front case 101a to complete the housing 101 and to protect the circuit devices, such as the circuit board 111 disposed within the housing 101.

The electromagnetic wave noise shield member 121 is mounted on the other side of the circuit board 111 to be interposed between the housing 101, more specifically the rear case 101b and the circuit board 111, so that the electromagnetic wave noise shield member 121 can shield electromagnetic waves produced from one or more integrated chips or electronic circuits from being diffused to any other chip or circuit, or to the outside of the terminal 100. Although only one electromagnetic wave shield member 121 is shown in the present embodiment for illustrative purposes, it may be equipped with two or more shield members according to the teachings of the present invention. If the noise shield member 121 is mounted on the circuit board 111, a space is formed between the electromagnetic wave noise shield member 121 and the circuit board 111. In other words, a space enclosed by the circuit board 111 and the electromagnetic wave noise shield member 121 defines a resonance space according to the inventive speaker device 102.

The speaker unit 123 includes a voice coil, a magnetic body, and a vibrating membrane to convert electric signals into sound and to output the sound. The speaker unit 123 is mounted on the electromagnetic wave noise shield member 121. A reception space 129a is formed on the electromagnetic wave noise shield member 121 to mount the speaker unit 123. The reception space 129a is formed by depressing/denting a part of the outer face of the electromagnetic wave noise shield member 121, so that the reception space 129a is positioned more closely to the circuit board 111 than the remaining part of the electromagnetic wave noise shield member 121 facing the circuit board 111.

In order to provide electric signals for the speaker unit 123, signal wiring 133 may be installed within the resonance space 131. The signal wiring 133 electrically connects the speaker unit 123 to the circuit board 111 to transfer electric sound signals to the speaker unit 123. For the purpose of enhancing a smoother sound output from the speaker unit 123, the speaker device 102 preferably includes rear openings 129b positioned behind the speaker unit 123, front openings 127 positioned in front of the speaker unit 123, and a sealing member 125 disposed between the electromagnetic wave noise shield member 121 and the rear case 101b.

The rear openings 129b are formed to extend from the reception space 129a to the resonance space 131 so that the sound produced from the speaker unit 125 is partially provided to the resonance space 131. The waves of the sound provided to the resonance space 131 produces resonances within the resonance space 131, thereby strengthening sound in the middle and bass regions.

The front openings 127 are formed to extend through the part of the housing 101 facing to the speaker unit, more specifically to extend from the inner side of the rear case 101b and to the outside of the housing 101. Most of the sound produced from the speaker unit 123 are outputted to the outside of the housing 101 through the front openings 127.

The sealing member 125 is arranged to prevent the sound from leaking out to the space between the inner face of the rear case 101b and the electromagnetic wave noise shield member 121, and to guide the sound produced from the speaker unit 123 to the front openings 127. The sealing member 125 is arranged to surround the reception space 129a on the outer face, in which one side of the sealing member 125 is attached to the electromagnetic wave noise shield member 121, and the other side is attached to the inner face of the housing 101. The sealing member 125 is formed from an elastic material, e.g. poron.

As described above, the sound produced from the speaker unit 123 is partially provided to the resonance space to produce resonance, and the resonance produced in the resonance space 131 strengthens the bass region of the sound produced from the speaker unit 123, thereby improving the sound quality of the speaker device 102.

Since the inventive speaker device secures a resonance space using an electromagnetic wave noise shield member mounted on a circuit board in a portable terminal, it is possible to improve sound quality while maintaining the size of the portable terminal to be the same. Further, the inventive speaker device uses the space formed by the electromagnetic wave noise shield member, which makes it easy to realize the miniaturization of a portable terminal as compared with a portable terminal that must secure a separate resonance space so as to have the same sound quality as the inventive speaker device.

While the invention has been shown and described with reference to certain embodiments thereof, it will be understood by those skilled in the art that various changes in form and details may be made therein without departing from the spirit and scope of the invention as defined by the appended claims.

What is claimed is:

1. A speaker device for a portable terminal, comprising:
an electromagnetic wave noise shield member mounted on a circuit board, defining a resonance space therebetween; and
a speaker unit mounted on the electromagnetic wave noise shield member; and
wherein the sound produced from the speaker unit is partially provided to the resonance space.

2. The speaker device as claimed in claim 1, wherein the electromagnetic wave noise shield member is formed from a metallic material.

3. The speaker device as claimed in claim 1, wherein the electromagnetic wave noise shield member further comprises a reception space to house the speaker unit.

4. The speaker device as claimed in claim 3, wherein a bottom of the reception space further comprises rear openings formed to extend the reception space to the inner face of the electromagnetic wave noise shield member,
wherein the sound produced from the speaker unit is partially provided to the resonance space through the rear openings.

5. The speaker device as claimed in claim 1, wherein the terminal comprises a housing to receive the circuit board and the electromagnetic wave noise shield member is interposed between the housing and the circuit board.

6. The speaker device as claimed in claim 5, wherein the electromagnetic wave noise shield member further comprises a reception space to house the speaker unit.

7. The speaker device as claimed in claim 6, further comprising a sealing member, one side of which is coupled to the electromagnetic wave noise shield member and the other side is coupled to the inner face of the housing,
wherein the sealing member being arranged on the outer face of the electromagnetic wave noise shield member to surround the reception space.

8. The speaker device as claimed in claim 6, wherein a bottom of the reception space further comprises openings formed to extend from the inner face of the housing facing to the speaker unit to the outer face of the housing.

9. A mobile terminal comprising:
a housing having a front cover and a rear cover;
a circuit board disposed within the housing;
an electromagnetic wave noise shield member mounted on the circuit board, defining a resonance space therebetween; and
a speaker unit mounted on the electromagnetic wave noise shield member so that an audio output the speaker unit is partially provided to the resonance space.

10. The mobile terminal as claimed in claim 9, wherein the electromagnetic wave noise shield member further comprises a reception space having openings so that the sound produced from the speaker unit is partially provided to the resonance space.

11. The mobile terminal claimed in claim 10, further comprising a sealing member disposed between the electromagnetic wave noise shield member and the rear cover and surrounding the reception space.

12. The mobile terminal as claimed in claim 9, wherein the rear cover further comprises openings over the speaker unit.

13. The mobile terminal as claimed in claim 9, wherein the electromagnetic wave noise shield member is formed from a metallic material.
